(19) United States
(12) Patent Application Publication
(10) Pub. No.: US 2008/0201353 A1
(43) Pub. Date: Aug. 21, 2008

(54) Data Delivery

(76) Inventor: Chuck Manning, Winterville, NC (US)

Correspondence Address: FAY KAPLUN & MARCIN, LLP, 150 BROADWAY, SUITE 702, NEW YORK, NY, 10038, US

(21) Appl. No.: 11/693,048

(22) Filed: Mar. 29, 2007

(30) Foreign Application Priority Data
Aug. 10, 2006 (GB) 0615857.0

(51) Int. Cl. G06F 17/30

(52) U.S. Cl. 707/102; 707/E17.009

(57) ABSTRACT

A system and method for sending a first request for first data, receiving, in reply, one or more data structures for accessing a first plurality of data fragments, using the one or more data structures to create and send a second plurality of second requests for data fragments of the first data, receiving, in reply to the second requests, at least each of the first plurality of data fragments, using the first plurality of data fragments to create the first data and storing one or more, but not all, of the first plurality of data fragments.

### FIELD OF THE INVENTION

Embodiments of the present invention relate to data delivery. In particular, they relate to data delivery using a peer-to-peer network.

### BACKGROUND TO THE INVENTION

A problem exists in relation to delivery, via a data network, of data structures such as images, databases, files, movies etc.

If a traditional client-server model is used for a delivery system, the server stores multiple data structures and each client obtains a data structure from the server. The client-server model has the advantage that access to the data structure can be easily controlled using the server. However, a disadvantage is that the bandwidth of the network connection to the server must increase dramatically as the number of clients and data structures stored increases.

In a traditional peer-to-peer (P2P) model, a peer (operating as a client) downloads a data structure from another peer (operating as a server) and then operates as a server for the downloaded data structure. This model has the advantage that there is no bandwidth bottleneck but has the disadvantage that access to a data structure once released onto the P2P network is not controlled.

### BRIEF DESCRIPTION OF THE INVENTION

Embodiments of the invention do not require the storage of all data structures in a single server. Instead the data structures are dispersed over many delivery apparatuses. This solves the problem of bandwidth bottleneck associated with a single server.

Embodiments of the invention avoid the storage, for delivery of the whole of a data structure in a single distribution apparatus. Instead fragments of the data structure are stored, for delivery, at different distribution apparatuses. This spreads the storage burden across a number of distribution apparatuses and also provides control of the data structure as no one distribution apparatus stores the whole of the data structure.

Embodiments of the invention enable the growth of a peer-to-peer network. After a requester apparatus receives the fragments of a data structure it becomes a distribution apparatus for one or more of those fragments.

Control of the delivery of a data structure is controlled by requiring that a requester apparatus communicate with an administrator apparatus to obtain information that enables it to obtain and combine the fragments of a data structure. The data structure is created at a requestor apparatus only if it obtains this information and the administrator apparatus can control the dissemination of that information.

According to one embodiment of the invention there is provided

According to one embodiment of the invention there is provided a method comprising; sending a first request for first data; receiving, in reply, one or more data structures for accessing a first plurality of data fragments; using the one or more data structures to create and send a second plurality of second requests for data fragments of the first data; receiving, in reply to the second requests, at least each of the first plurality of data fragments; using the first plurality of data fragments to create the first data; and storing one or more, but not all, of the first plurality of data fragments.

According to one embodiment of the invention there is provided a computer program product comprising code that enables: sending a first request for first data; using one or more data structures, received in reply to the first request, to create and send a second plurality of second requests; using a first plurality of data fragments, received in reply to the second requests, to create the first data; and storing for access one or more, but not all, of the first plurality of data fragments.

According to one embodiment of the invention there is provided an apparatus comprising: a memory; a communications interface for sending a first request for first data and a second plurality of second requests for data fragments of first data and for receiving, in reply to the first request, one or more data structures for creating the second requests and for receiving, in reply to the second requests, at least a first plurality of data fragments for creating the first data; and processing circuitry operable to use the received one or more data structures to create the second plurality of second requests and to use the first plurality of data fragments to create the first data and operable to store one or more, but not all, of the first plurality of data fragments in the memory for distribution.

According to one embodiment of the invention there is provided a method, for performance at an apparatus, comprising: repeatedly informing an administration apparatus of a status of the apparatus; receiving a first data fragment of first data from the administration apparatus; receiving a second data fragment of second data from the administration apparatus; in response to receiving a request identifying the first data fragment sending, in reply, the identified first data fragment; and in response to receiving a request identifying the second data fragment sending, in reply, the identified second data fragment.

According to one embodiment of the invention there is provided an always-on apparatus comprising: a communications interface that is operable to repeatedly inform an administration apparatus of its status, receive a first data fragment of first data from the administration apparatus and receive, separately, a second data fragment of second data from the administration apparatus; and processing circuitry continuously operable, in response to receiving a request identifying the first data fragment, to enable the sending, in reply, the identified first data fragment and continuously operable, in response to receiving a request identifying the second data fragment, to enable sending, in reply, the identified second data fragment.

According to one embodiment of the invention there is provided a computer program product comprising code that enables an apparatus to: repeatedly inform an administration apparatus of a status of the apparatus; store a received first data fragment of first data; store a received second data fragment of second data; to send, in response to receiving a request identifying the first data fragment, the identified first data fragment; and to send, in response to receiving a request identifying the second data fragment, the identified second data fragment.

According to one embodiment of the invention there is provided a method comprising: fragmenting data into a first plurality of data fragments; dispersing the first plurality of data fragments over a second plurality of distribution apparatuses; and storing one or more data structures that enable a requestor apparatus to access the dispersed first plurality of data fragments.

According to one embodiment of the invention there is provided an apparatus comprising: a processor operable to fragment data into a first plurality of data fragments; a communications interface operable to disperse the first plurality of data fragments over a second plurality of distribution apparatuses; and a memory for storing one or more data structures that enable a requester apparatus to access the dispersed first plurality of data fragments.

According to one embodiment of the invention there is provided a computer program product comprising code that enables: fragmenting data into a first plurality of data fragments; dispersing the first plurality of data fragments over a second plurality of distribution apparatuses; and storing one or more data structures that enable a requester apparatus to access the dispersed first plurality of data fragments.

According to one embodiment of the invention there is provided a data delivery method comprising: enabling a requesting apparatus that requests first data to obtain the first data as a first plurality of data fragments from a second plurality of distribution apparatuses; and enabling the requesting apparatus to become subsequently a distribution apparatus for only a sub-set of the first plurality of data fragments.

### BRIEF DESCRIPTION OF THE DRAWINGS

For a better understanding of the present invention reference will now be made by way of example only to the accompanying drawings in which:

FIG. 1 schematically illustrates a data delivery system;

FIG. 2 illustrates a fragmentation process;

FIG. 3 illustrates a de-fragmentation process;

FIG. 4 schematically illustrates an example of a record;

FIG. 5 illustrates a process by which a distribution apparatus provides information to an administrator apparatus,

FIG. 6 schematically illustrates an apparatus operable as a requestor apparatus 8, a distribution apparatus, an administration apparatus, a data provider apparatus; and

FIG. 7 illustrates a physical entity embodying a computer program.

### DETAILED DESCRIPTION OF EMBODIMENTS OF THE INVENTION

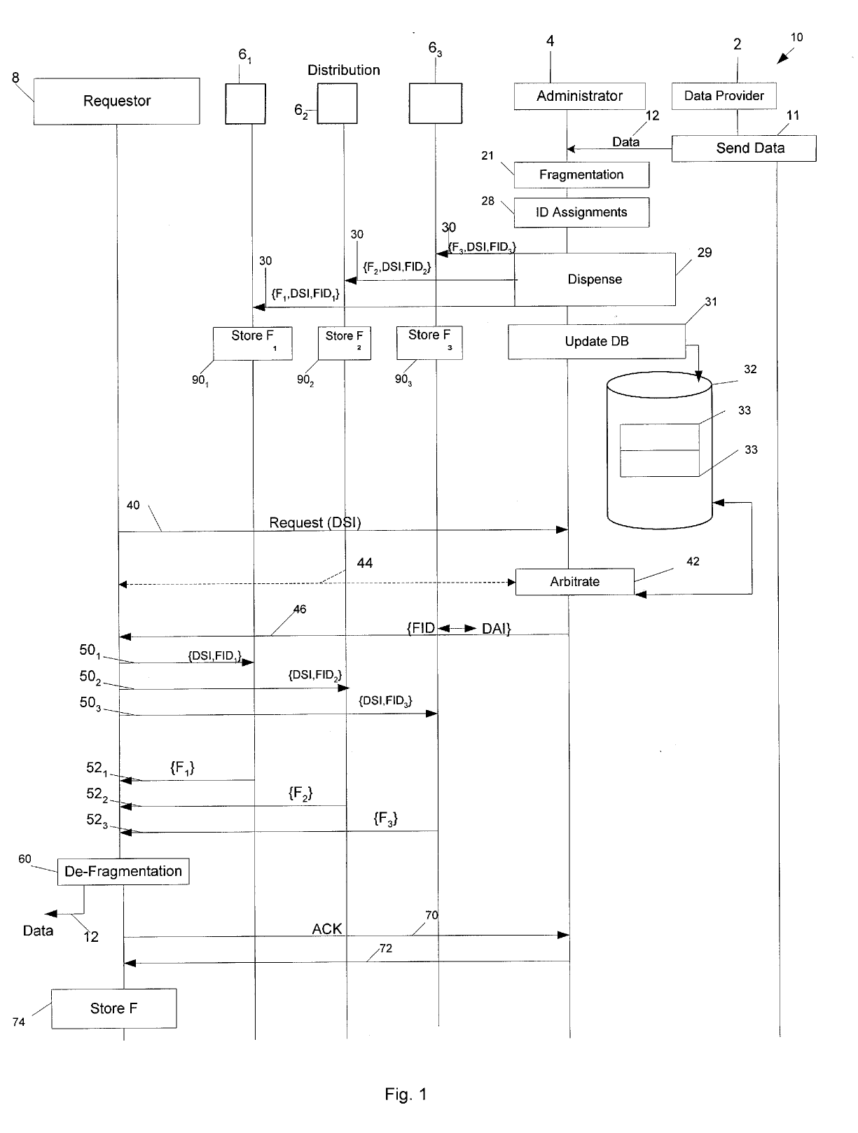

FIG. 1 schematically illustrates a data delivery system 10, The system comprises: a data provider apparatus 2; an administrator apparatus 4; distribution apparatuses 6₁, 6₂, 6₃ and a requester apparatus 8.

The different apparatuses may communicate via a data network such as the Internet, Wide Area Network (WAN), Local Area Network (LAN) etc.

The data provider apparatus 2 sends, at block 11, a first data structure 12 to the administrator apparatus 4.

The first data structure 12 may be any suitable collection of data it may, for example, be a film, a music track, an image, a database etc.

The administrator apparatus 4 fragments, at block 21, the first data structure 12 creating a set 26,27 of N of data fragments F₁, F₂, F₃ . . . F_{N}. It should be appreciated that the value of N may be fixed or may vary with different data structures.

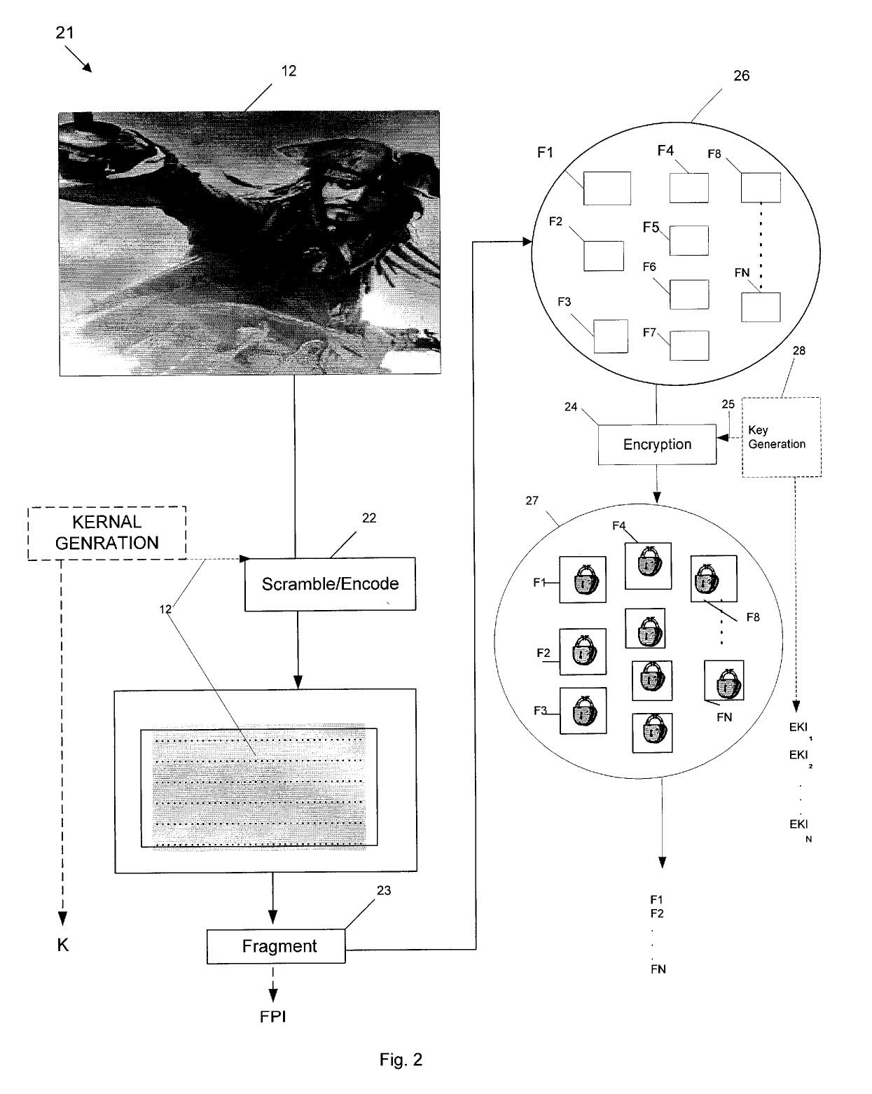

One example of the fragmentation process 21 is illustrated in FIG. 2.

A subject data structure 12 is scrambled (or otherwise encoded) at block 22 to create a scrambled/encoded data structure 12′. The scrambling occurs in a predetermined manner e.g. by changing the position/order of data portions within the data structure 12. The scrambling process may use a different randomly generated kernel K for each data structure 12.

Next the scrambled data structure 12′ is fragmented at block 23 into a set 26 of N non-overlapping independent data portions or fragments F₁, F₂, F₃ . . . F_{N} according to a predetermined fragmenting procedure. In some implementations, a number of different fragmenting procedure may be used, each of which can be identified by a different fragmenting procedure identifier (FPI).

In some implementations, the output of the fragmentation process 21 is the output of the fragmenting procedure 23.

In other implementations, the output of the fragmenting procedure 23 is encrypted to become the output of the fragmentation process 21. The data fragments F₁, F₂, F₃ . . . F_{N} are separately encrypted at block 24. In some implementations, the same encryption process may be used for all data fragments F. In other implementations, a different encryption key 25 may be used for encrypting each data fragment F. The keys may be generated in key generation block 26 and each key may be identified by an encryption key identifier (EKI). The EKI may be the key itself or an address in a look-up table listing the keys.

The encryption block 24 produces a set 27 of N encrypted data fragments F.

Referring back to FIG. 1, next at block 28, a unique data structure identifier (DSI) is assigned to the received data structure 12 and a different fragment identifier FIDᵢ is assigned to each of the fragments Fᵢ. Thus any fragment Fᵢ of a data structure 12 may be uniquely referenced by the combination of a DSI and a FIDᵢ.

Next at block 29, the fragments F are dispersed amongst a plurality M of distribution apparatuses 6. A distribution apparatus 6 may store only m fragments of a particular data structure, where m<N. In one implementation, m is one.

Each distribution apparatus 6 has its own apparatus identifier (AI) which may be for example, an Internet protocol (IP) address. The fragments F may be dispersed by sending a message 30 to each of the M distribution apparatuses.

The administrator apparatus 4, at block 31, updates a database 32. The database 32 has a separate record 33 for each data structure 12 and the record 33 may be addressed using the assigned data structure identifier (DSI).

A record 33 is a data structure used to store information concerning a subject data structure 12 and it enables a remote requesting apparatus 8 to create the originally received subject data structure 12 from dispersed fragments F of the data structure 12.

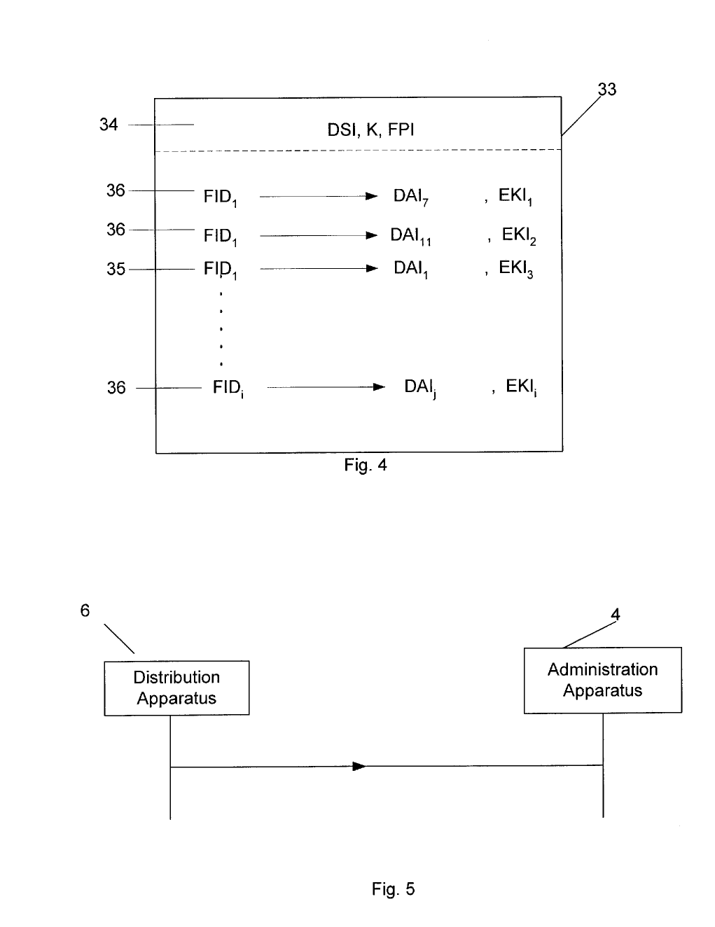

One example of a record is schematically illustrated in FIG. 4. A record 33 may have a header 34 that comprises its associated data structure identifier DSI, and if used, the scrambling kernel K and fragmenting procedure identifier FPI associated with the production of fragments F from the subject data structure 12.

The record 33 may have a body 35 that has a plurality of entries 36. An entry 36 is used to map a FID for the associated data structure 12, to a distribution apparatus identifier or identifiers (DAI) to which that fragment is dispersed.

If a data fragment Fᵢ has been independently encrypted before dispersal, then the entry 36 for that fragment, will also associate with the FID for that fragment the correct encryption key identifier (EKI) that is or identifies the encryption key used to encrypt/decrypt the fragment.

A message 30 contains a fragment Fᵢ, and a fragment address that enables any requester apparatus 8 to access that data fragment after dispersal. A suitable fragment address is the combination of the DSI associated with the data structure 12 and the FID associated with the fragment.

A distribution apparatus 6, on receiving a message 30, extracts the content of the message and stores the data fragment F received in the message at block 90 in a manner that allows it to be referenced by the fragment address.

In one implementation, the number of fragments N is the same as the number M of distribution apparatuses 8 amongst which the fragments are dispersed and any one distribution apparatus may store only one fragment of a particular data structure 12. Although a distribution apparatus 8 may store multiple fragments, they will relate to different data structures, as the distribution apparatus may store only one fragment of a particular data structure.

It should be appreciated that the same or a different data provider apparatus 2 may provide a second data structure 12 to the administrator apparatus 4, which will in turn fragment that second data structure and disperse those second fragments amongst distribution apparatuses 6 which may or may not include the distribution apparatuses over which the first fragments of the first data structure 12 were dispersed. The database 32 is updated to include a new record 33 for the second data structure as described above.

The process of data retrieval by a requester apparatus 8 will now be described. The requester apparatus 8 requests a particular data structure 12 by sending a request 40 to the administrator apparatus 4.

The request 40 identifies the required data structure, for example, by including the DSI of the required data structure and also an identifier of the requester apparatus (RAI), for example, using an IP address.

The administrator apparatus 4 receives the request 40 and arbitrates the request 40 at block 42. It arbitration is successful, the record 33 in the database 32 associated with the required data structure is accessed and it or a portion of it is sent to the requester apparatus 8 as message 46.

The arbitration process 42 may include an authentication procedure and/or payment procedure. For example, in a membership implementation, the RDI received in the request may be compared against a membership log to check whether the requester apparatus 8 is authorised to have access to the requested data structure. As another example, in a shop-front implementation, the receipt of the request may initiate a payment procedure by which a payment is made from the requestor apparatus 8 to the administrator apparatus 4.

The arbitration process 42 may also involve the creation 44 of a secure communication channel between the requestor apparatus 8 and the administrator apparatus 4. In one embodiment this may be achieved by including within the request 40 the public key of the requester apparatus 8, generating an encryption key at the administrator apparatus 4, encrypting the generated key with the public key and sending the result to the requester apparatus B. The requester apparatus 8 uses its own secret private key to recover the generated encryption key from the received result. The generated encryption key may then be used to encrypt information from the record 33 before it is transmitted to the requester apparatus 8 as message 46 and used at the requester apparatus 8 to recover the original information from the record 33.

The received record information identifies a plurality of distribution apparatuses 8 and the data fragments F of the requested data structure 12 that are stored at those apparatuses. For example, the received information may include the mappings of FID to DAI discussed in relation to FIG. 4.

The requester apparatus 8 creates a fragment access request 50 for each of the identified distribution apparatuses 6. A fragment access request 50 includes a fragment address which may be a combination of a DSI and a. FIDᵢ.

The multiple fragment access requests 50 created may be sent in parallel to the respective distribution apparatuses 6.

A distribution apparatus 6 responds to receiving a fragment access request 50 by accessing the stored fragment F identified by the fragment address in the request 50 and returning, in a reply message 52, the accessed fragment F to the apparatus 8 from which the fragment access request 50 was received.

In the implementation where N=M and m=1, N fragment access requests are created and sent to the N distribution apparatuses, which return N fragments.

The fragments F received by the requester apparatus 8 are used, in block 60, to create the original data structure 12 in a de-fragmentation process which is the reverse of the fragmentation process 21.

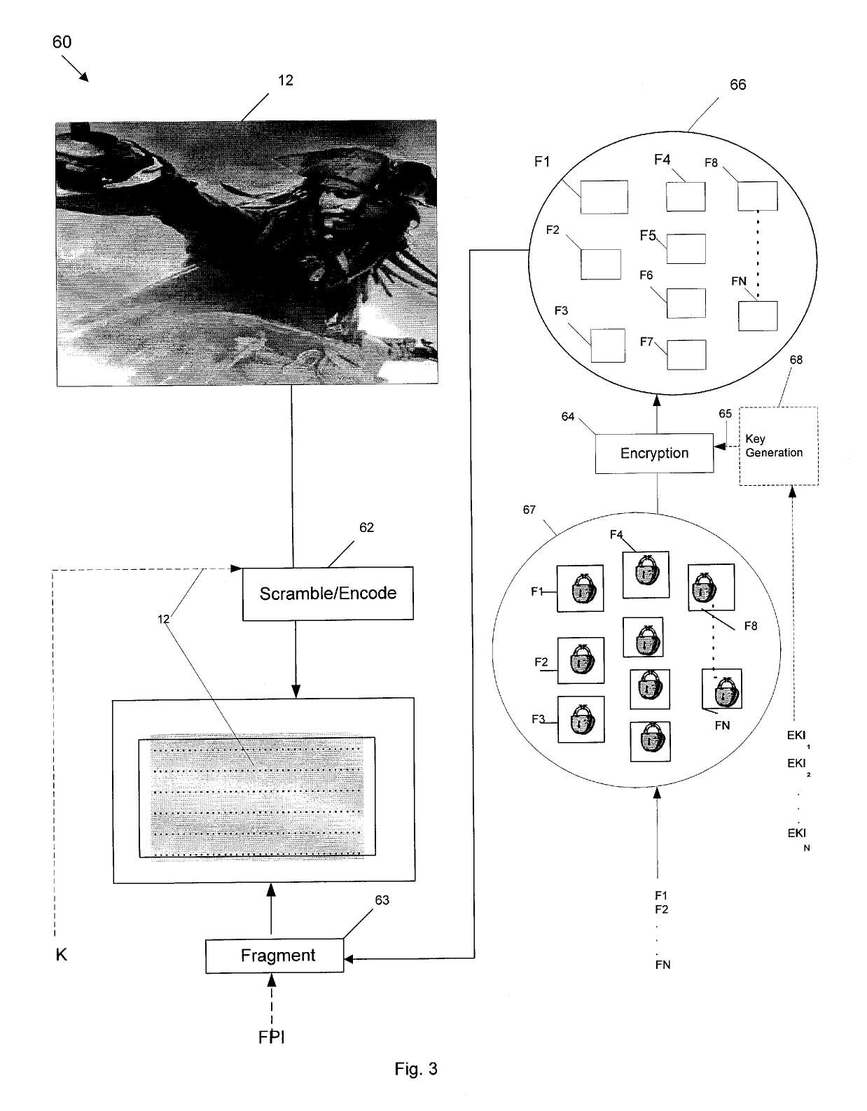

If the process illustrated in FIG. 2, was used for fragmentation, the process illustrated in FIG. 3 may be used for de-fragmentation.

A set 67 of N encrypted data fragments F are provided to decryption block 64.

The data fragments F₁, F₂, F₃ . . . F_{N} are separately decrypted at block 64 to produce a set 66 of N scrambled data fragments F. In some implementations, the same decryption process may be used for all data fragments F. In other implementations, a different decryption key 65 may be used for decrypting each data fragment F. A key for a particular fragment Fᵢ may be generated in key generation block 68 using the encryption key identifier (EKIᵢ) for that fragment, obtained from the received record 33.

Next the set 66 of N (scrambled) data fragments F are de-fragmented at block 63 to create a scrambled data structure 12′. If a number of different de-fragmenting procedures are possible, the correct de-fragmentation procedure 63 is identified using an FPI from the received record 33.

The scrambled data structure 12′ is de-scrambled (or decoded) at block 62 to create a the subject data structure 12. The descrambling occurs in a predetermined manner e.g. by changing the position/order of data portions within the data structure 12. If the de-scrambling process may use a different randomly generated kernel K for each data structure 12, the correct K is taken from the received record 33.

Thus the original data structure 12 is recovered from a plurality of fragments dispersed over a number of distribution apparatuses 6.

Returning to FIG. 1, after de-fragmentation 60, the original data structure 12 is available in the requester apparatus 8 for use. Other actions in respect of the data structure 12 may be restricted. For example, storage of the data structure 12 may or may not be permitted if storage is allowed it may only be allowed in a manner that prevents access by a third party or distribution to a third party. Copying, distribution etc of the data structure may or may not be permitted.

When the original data structure 12 has been successfully created from the fragments F, which may be verified using a checksum or similar, the requester apparatus 8 sends an acknowledgement message 70 to the administrator apparatus 4 indicating that the data structure 12 has been successfully assembled from the dispersed fragments F.

The administrator apparatus 4 responds to the received acknowledgement by sending a command 72 that instructs the requester apparatus 8 to store a sub-set n of the N fragments it received and assembled to create the data structure 12 and to operate as a distribution apparatus 6 in respect of those n fragments.

In one implementation, the value of n is always one.

The requester apparatus 8, on receiving the command 72, stores the data fragment(s) F identified in the command at block 74 in a manner that allows the data fragment(s) to be referenced by subsequently received fragment address(es).

The administrator apparatus 4, at block 76, updates the database 32 to include an additional or replacement entry or entries 36 in the record 33 for the subject data structure 12. The new entry or entries 36 map the requester apparatus 8 to the fragment or fragments of the subject data structure 12 stored on that requester apparatus 8. Thus when a further requester apparatus requests the same data structure 12, the procedure is the same as described above for FIG. 1, except that the further requester apparatus operates as the ‘requester apparatus 8’ and the original requester apparatus may operate as one of the distribution apparatuses 6.

FIG. 5 illustrates a process by which a distribution apparatus 6 provides information 100 to the administrator apparatus 4.

A distribution apparatus may be always-on or sometimes-on. An always-on distribution apparatus (a drone peer) may send information 100 periodically or whenever a trigger event occurs. As the drone peer is always on, the information 100 typically informs the administration apparatus of its available resources such as available memory for use and available bandwidth for use. It may also inform a change in IP address.

A sometimes-on distribution apparatus (a peer) will send information 100 when it is switched on and ready to participate in the system 10 and may subsequently send information 100 periodically or whenever a trigger event occurs or when the peer is no longer able to participate in the system.

As the peer is not always on, the information 100 typically may either inform the administration apparatus of its available resources such as available memory for use and available bandwidth for use or of its availability e.g. that it has joined the system 10 or is leaving the system 10. It may also inform a change in IP address.

An always-on distribution apparatus 6 may be a dedicated to distribution of fragments within the network and be owned and controller by the owners/controllers of the administrator apparatus 4.

A sometimes-on distribution apparatus 6 will not be a dedicated to distribution of fragments within the network and is generally owned and controller by someone other than the owners/controllers of the administrator apparatus 4 such as a user of the system. A sometimes-on distribution apparatus 6 may be created from a requestor apparatus as described in relation to FIG. 1.

The information 100 provides the administration apparatus 4 with information that enables it to optimise the data delivery service provided by the system 10 and, in particular, to optimise the content of the message 46 which instructs a requester apparatus 8 which distribution apparatuses 6 should be accessed to obtain a particular fragment.

As will be appreciated from the foregoing, a record 33 for a data structure 12 may have multiple entries for a single fragment. Each entry may identify a different distribution apparatus at which that fragment is stored.

The administration apparatus 4 may select a sub-set of those multiple entries, so that, for example, only entries relating to available or active distribution apparatuses 6 are included.

The administration apparatus may prioritise the Multiple entries, based on the prior use of the distribution apparatuses 6 associated with the entries and based on the resources of the distribution apparatuses 6 associated with the entries.

Typically, the distribution of a new data structure 12 starts by dispersing fragments F only to the dedicated, always-on distribution apparatuses (drone peers). With each subsequent download of the data structure 12 to a data requestor apparatus 8, a new distribution apparatus (peer) is created for some, but not all, of the fragments used to create the data structure. In one implementation, a distribution apparatus can only store a single fragment of any one data structure. Thus with each download the system 10 for that data structure expands to form a peer-to-peer network with an administrative function 4.

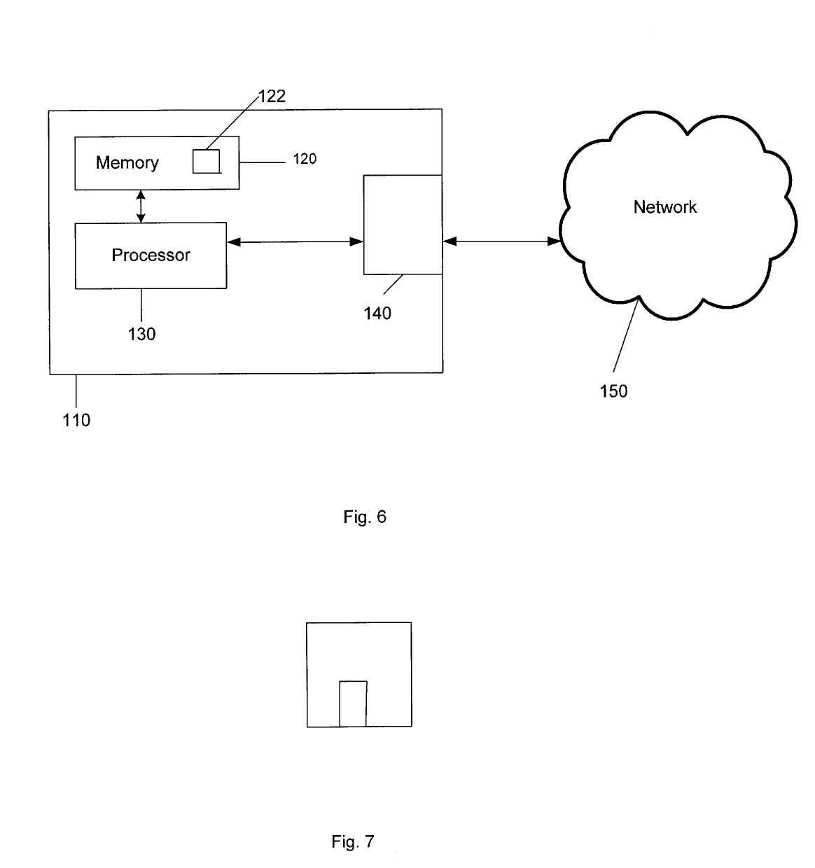

FIG. 6 schematically illustrates an apparatus 110 operable as the requester apparatus 8, a distribution apparatus 6, the administration apparatus 4 or the data provider apparatus 2.

The apparatus 110 comprises a processor 130, a memory 120 and a communications interface 140. The processor 130 may be any suitable processing circuitry e.g. a microprocessor. The memory 120 may be written to and read from by the processor 130. The communications interface 140 is for connection to a network 150 and is used to transmit and receive the messages illustrated in FIGS. 1 and 4.

The processor 130 is able to process messages received at the communications interface 140 from the network 150 and is operable to create messages for sending into the network 150 via the communications interface 140.

The capability of the apparatus 110 depends upon a computer program 122 stored in the memory 120.

The same computer program 122A may be used to control the apparatus 110 to operate as a requestor apparatus 8 and a distribution apparatus 6. The computer program when downloaded onto an apparatus 110 is initially in a ‘requestor only mode’ and enables the apparatus 110 to operate as a requestor apparatus 8. After downloading a data structure 12, the apparatus 110 then enters a ‘distribution mode’ and is operable as a distribution apparatus for a data fragment of the downloaded data structure and as a requestor apparatus 8 for additional data structures.

The computer program instructions 122A control the operation of the apparatus 110 when loaded into the processor 130. The computer program instructions 122A provide the logic and routines that enables the electronic apparatus to perform the methods described and/or as illustrated in FIGS. 1, 3 and 5 that are performed by a requester apparatus 8 and/or a distribution apparatus 6.

The computer program instructions 122A may arrive at the apparatus 110 via an electromagnetic carrier signal, for example, via the network 150 or be copied from a physical entity 160 (FIG. 7) such as a computer program product, a memory device or a record medium such as a CD-ROM or DVD.

A different computer program 122B may be loaded into memory 120 as an alternative to computer program 122A. The computer program instructions 122B control the operation of the apparatus 110 when loaded into the processor 130. The computer program instructions 122B provide the logic and routines that enables the apparatus 110 to perform the methods described and/or as illustrated in FIGS. 1, 2, 4 and 5 that are performed by an administrator apparatus 4

The computer program instructions 122B may arrive at the apparatus 110 via an electromagnetic carrier signal, for example, via the network 160 or be copied from a physical entity 160 (FIG. 7) such as a computer program product, a memory device or a record medium such as a CD-ROM or DVD.

Although embodiments of the present invention have been described in the preceding paragraphs with reference to various examples, it should be appreciated that modifications to the examples given can be made without departing from the scope of the invention as claimed. For example, the message 46 may be sent as a series of messages and the record 33 may be sent to the requestor apparatus as a plurality of data structures.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. A method comprising:
sending a first request for first data;
receiving, in reply, one or more data structures for accessing a first plurality of data fragments;
using the one or more data structures to create and send a second plurality of second requests for data fragments of the first data;
receiving, in reply to the second requests, at least each of the first plurality of data fragments;
using the first plurality of data fragments to create the first data; and
storing one or more, but not all, of the first plurality of data fragments.

2. A method as claimed in claim 1, wherein only one of the first plurality of data fragments is stored.

3. A method as claimed in claim 1, further comprising:
sending the stored one or more data fragments to an apparatus in response to receiving a second request identifying the stored fragment(s) from that apparatus.

4. A method as claimed in claim 1, wherein at least some of the second plurality of second requests are sent in parallel.

5. A method as claimed in claim 1, wherein each second request requests a single data fragment.

6. A method as claimed in claim 1, wherein the first request for first data is sent to an administrative apparatus.

7. A method as claimed in claim 1, wherein the data fragments are distributed across a second plurality of distribution apparatuses.

8. A method as claimed in claim 1, wherein the received data structure identifies the first plurality of data fragments and maps each data fragment to a respective one of the second plurality of distribution apparatuses at which that data fragment is stored.

9. A method as claimed in claim 8, wherein the first plurality and second plurality are the same number.

10. A method as claimed in claim 1, wherein the data structure maps by one-to-one correspondence, data fragments and distribution apparatuses.

11. A method as claimed in claim 1, wherein the second requests are sent to distribution apparatuses.

12. A method as claimed in claim 1, wherein there is a different one second request for each one of the first plurality of data fragments.

13. A method as claimed in claim 1, wherein the data fragments are encrypted portions of the first data.

14. A method as claimed in claim 1, wherein the data fragments are portions of scrambled first data.

15. A system comprising a memory storing lines of code and a processor for executing the code, the code being operable to:
send a first request for first data;
using one or more data structures, received in reply to the first request, to create and send a second plurality of second requests;
using a first plurality of data fragments, received in reply to the second requests, to create the first data; and
store for access one or more, but not all, of the first plurality of data fragments.

16. An apparatus comprising:
a memory;
a communications interface for sending a first request for first data and a second plurality of second requests for data fragments of first data and for receiving, in reply to the first request, one or more data structures for creating the second requests and for receiving, in reply to the second requests, at least a first plurality of data fragments for creating the first data; and
processing circuitry operable to use the received one or more data structures to create the second plurality of second requests and to use the first plurality of data fragments to create the first data and operable to store one or more, but not all, of the first plurality of data fragments in the memory for distribution.

17-19. (canceled)

20. A method comprising:
fragmenting data into a first plurality of data fragments;
dispersing the first plurality of data fragments over a second plurality of distribution apparatuses; and
storing one or more data structures that enable a requester apparatus to access the dispersed first plurality of data fragments.

21. A method as claimed in claim 20, wherein dispersing data fragments includes sending a fragment to a distribution apparatus along with a fragment address for that fragment.

22. A method as claimed in claim 20, further comprising:
receiving a first request for first data from a requester apparatus; and
sending, to the requester apparatus in reply, at least portions of the stored one or more data structures that enable access to the first plurality of data fragments.

23. A method as claimed in claim 22, wherein the information sent to the requester apparatus in reply maps data fragments to distribution devices.

24. A method as claimed in claim 23, wherein the information includes one of more encryption keys.

25. A method as claimed in claim 20, further comprising:
receiving an acknowledgement from the requestor apparatus;
commanding the requestor apparatus to store a sub-set, but not all, of the first plurality of data fragments; and
updating the stored one or more data structures to record that the sub-set of data fragments are accessible from the requester apparatus.

26. A method as claimed in claim 20, further comprising scrambling the data before fragmentation.

27. A method as claimed in claim 20, further comprising encrypting the data fragments before dispersal.

28. A apparatus comprising:
a processor operable to fragment data into a first plurality of data fragments;
a communications interface operable to disperse the first plurality of data fragments over a second plurality of distribution apparatuses; and
a memory for storing one or more data structures that enable a requestor apparatus to access the dispersed first plurality of data fragments.

29. A system comprising a memory storing lines of code and a processor for executing the code, the code being operable to:
fragment data into a first plurality of data fragments;
disperse the first plurality of data fragments over a second plurality of distribution apparatuses; and
store one or more data structures that enable a requester apparatus to access the dispersed first plurality of data fragments.

30. A data delivery method comprising
enabling a requesting apparatus that requests first data to obtain the first data as a first plurality of data fragments from a second plurality of distribution apparatuses; and
enabling the requesting apparatus to become subsequently a distribution apparatus for only a sub-set of the first plurality of data fragments.

31-32. (canceled)
